(19) United States
(12) Patent Application Publication
(10) Pub. No.: US 2005/0169253 A1
(43) Pub. Date: Aug. 4, 2005

(54) WLAN communication service platform

(76) Inventor: Qingmin Hu, Danville, CA (US)

Correspondence Address: Qingmin Hu, 314 Mountain Ridge Drive, Danville, CA, 94506, US

(21) Appl. No.: 11/049,472

(22) Filed: Feb. 1, 2005

Related U.S. Application Data
(60) Provisional application No. 60/541,507, filed on Feb. 3, 2004.

(51) Int. Cl. H04L 12/66

(52) U.S. Cl. 370/352

(57) ABSTRACT

A service platform for providing mobility and for actively managing intelligent mobile services is described. At least some embodiments of the invention comprise a platform that actively manages different services (e.g., as classified by priority and delivered and billed accordingly). In particular, embodiments of the present invention contemplate delivering services such as high priority traffic like voice and messages with different priorities using technologies such as DiffServ, SIP and VoIP to the customer. In this manner, embodiments of the invention provide a service and application platform for real-time, intelligent communication services. In addition, at least some embodiments of the invention contemplate a billing system that enables differential billing for the provision of platform services.

### CROSS-REFERENCE TO RELATED APPLICATION

This application claims the benefit of the filing date of U.S. provisional patent application Ser. No. 60/541,507 entitled A WLAN Communication Service Platform, filed Feb. 3, 2004.

### BACKGROUND

With the recent advance in WLAN technologies and Voice over IP (VOIP), it is now possible to create an all IP-based communication device that uses standard Internet protocols to deliver multimedia services including voice, video, and instant messaging. However, no systems currently exist for providing mobility and for managing intelligent services.

### SUMMARY

Embodiments of the invention comprise a service platform for providing mobility and for actively managing intelligent mobile services. More specifically, at least some embodiments of the invention comprise a platform that actively manages different services (e.g., as classified by priority and delivered and billed accordingly). In particular, embodiments of the present invention contemplate delivering services such as high priority traffic like voice and messages with different priorities using technologies such as DiffServ, SIP and VoIP to the customer. In this manner, embodiments of the invention provide a service and application platform for real-time, intelligent communication services. In addition, at least some embodiments of the invention contemplate a billing system that enables differential billing for the provision of platform services.

### BRIEF DESCRIPTION OF THE DRAWING FIGURES

FIG. 1 illustrates a service platform of the present invention with end to end client and server architecture.

FIG. 2 illustrates client service manager (CSM) software components contemplated by the present invention.

FIG. 3 illustrates network service manager (NSM) components and signal flow contemplated by the present invention.

FIG. 4 illustrates the Front-end Service Router contemplated by the present invention.

FIG. 5 illustrates general message flow within the service platform 100 contemplated by the present invention.

FIG. 6 illustrates the process for a new user to sign up for services or existing users to subscribe for new services.

FIG. 7 illustrates a user login and registration process.

FIG. 8 depicts a process for establishing or setting up a voice call that utilizes our platform.

FIG. 9 depicts the differential billing process using the Front-end Service Router 130 and the online billing and accounting server.

### DESCRIPTION

At least some embodiments of the present invention contemplate linking applications/services such as a voice call, a IM message, a chat session, or browsing the web with an underlying transport (for example, a priority class for the voice call and less priority for a chat session, and even less priority for web browsing). In particular, embodiments of the present invention contemplate providing a class of service at the application level using the precedence bits or DiffServ codes at the transport level by the end devices (i.e., at the end points of communication) to represent these classes (thus enabling individualized services and “smart” billing). Differential Service (DiffServ) is an IP network model where traffic is treated by network elements (routers) with relative priorities based on the traffic class. The traffic is differentiated by marking the type of service (ToS) byte in the IP header. A 6-bit pattern (e.g., DSCP, DiffServ Code Points) in the IPv4 ToS field (or the IPv6 Traffic Class field) is used for marking the traffic class. For example, 001010 represents class 1 traffic, 010010 represents class 2 traffic and so on. Applications can be divided into different classes based on the priority and the traffic associated with each of the applications can then be marked by the DSCP for relative priority treatment by the network

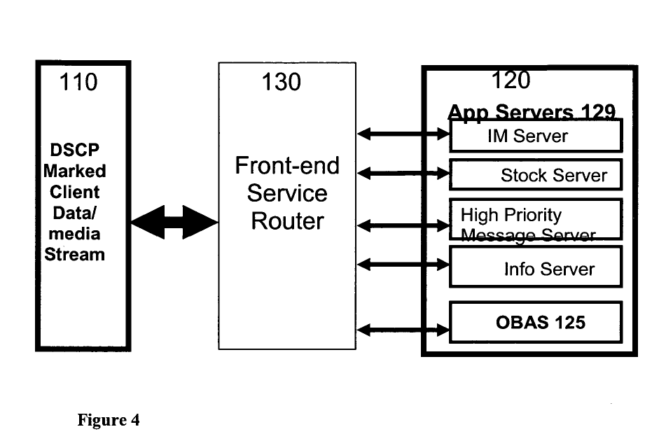

The present invention contemplates linking the class of services at the application level with the priority traffic routing at the transport level. On the client side, application service classes are classified by using DSCP to mark packets. On the service side (see FIG. 4), these marked traffics can be routed by our front-end service router 130 which acts on the priority code (DSCP) to route traffic to its appropriate destination efficiently and with priority. For example, a customer may sign up for “gold” IM service which means that his/her IM messages will have high priority over all other traffics. Once these packets are marked at the device, it will get to a front-end router which will route these packets with high priority to its destination (i.e. IM application server 120).

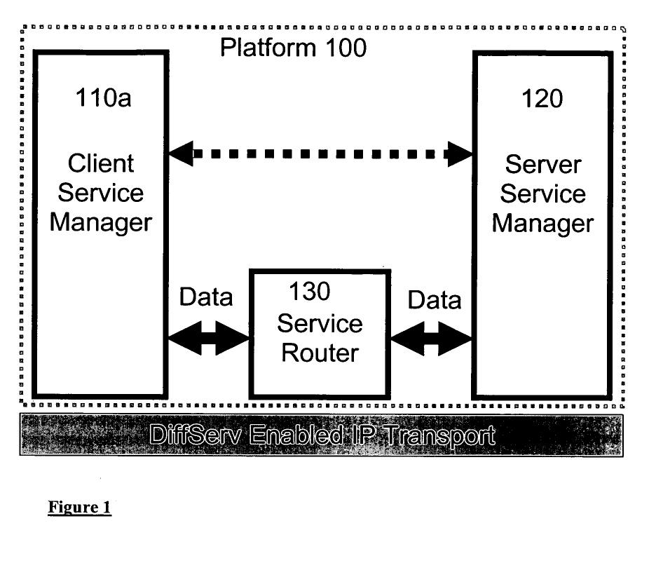

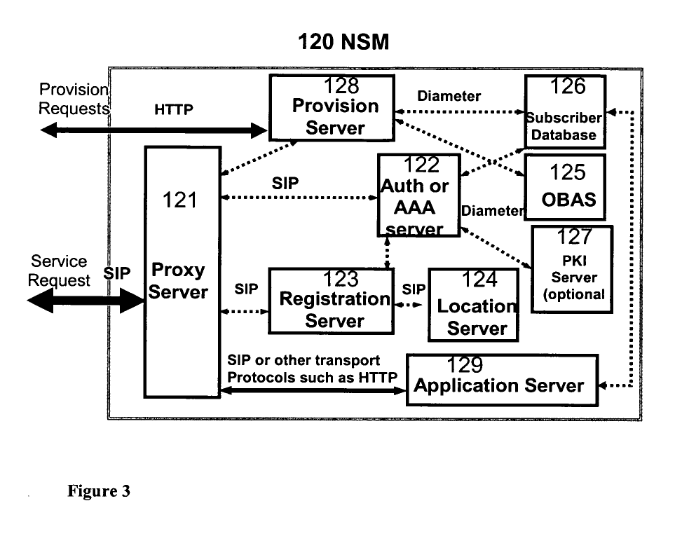

The present invention contemplates many broad types of traffic: for example, signaling and data (actual user media streams). An example of the signaling traffic would be the SIP messages used in setting up a session (i.e. a voice call), these message flows are represented as dotted lines in FIGS. 1 and 3. An example for data traffic would be media stream (i.e. a video clip, a MP3 song, a web browsing session, or a voice call). At the IP transport level, this traffic gets marked and differentially routed by a service router so proper priorities can be applied and billed. In some embodiments of the present invention, signaling traffic would be marked as highest priority.

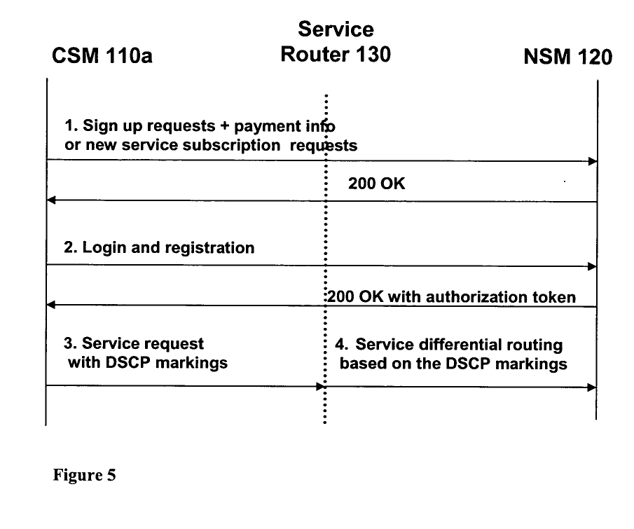

FIG. 1 illustrates a service platform of the present invention with end to end client and server infrastructure. Referring to FIG. 1, embodiments of the invention contemplate an intelligent communication services and application platform 100. In the embodiment of FIG. 1, system 100 may include three logical elements: a client device 110 linked to a network service manager 120 through a DiffServ-enabled service router 130. Examples of possible client devices include: handheld devices, cellular phones, wireless PDAs, etc. In at least some embodiments, client device 110 runs Client Service Manager (CSM) 110a (discussed in greater detail below). Server 120 consists of several logical elements with different functions. They can be on one hardware server (Examples of server include UNIX servers from Sun or IBM, it can also be Dell or other Intel-based servers running Linux) or each running on its own hardware depending on the implementation and deployment architecture). In at least some embodiments, server 120 runs a Network Service Manager (NSM) 120. In at least some embodiments, client platform 110 and network service platform 120 utilize Diffserv enabled IP network as the transport (or at least support IP precedence). In some embodiment, this is realized by enabling the client devices (through the client service manager 110) to mark packets using DSCP and by using the service router 130 to intelligently and efficiently route packets based on these DSCP markings. FIG. 5 shows an example of how the service platform works.

In addition, the present invention contemplates providing a service platform for end to end services based on, for example, an IP infrastructure.

At least some embodiments of the present invention can apply to other access networks (e.g., other than the WLAN) as long as the access network uses IP (or some other recognizable protocol) as the transport technology. In addition, some embodiments of the architecture as shown in FIGS. 3 and 4 on the network side 120 and 130 can be readily adoptable in providing a data service platform in different network implementations.

At least some embodiments of the present invention contemplate using a registration mechanism to register an AP (access points)'s IP address along with user's data to solve the routing problem associated with IPv4 and roaming in the WLAN environment.

At least some embodiments of the present invention contemplate utilizing an all IP-based system with open and standard technologies. As a result, the present invention ensures that the system is adaptive to the rapidly advancing Internet technologies. For example, the present invention will be able to support next generation Internet technologies such as IPv6.

Since it contains client and server platforms and utilize an all IP-transport, some embodiments of the present invention will be able to guarantee an end-to-end secure communication with the support of a PKI (public key infrastructure) system. The standard Internet security technologies (IKE, 3DES or AES encryption, and client digital certificates) can be deployed to ensure end-to-end communications for both voice (phone calls) and data communications. No separate encryption technologies will be needed for voice or data.

At least some embodiments of the present invention contemplate providing an integrated service environment for both voice and data applications by using VoIP technology. As a result, this will lower cost per bit over a uniform, open standard set of Internet based network. In other words, all communications will use packet based IP network for all traffic, thus reduce costs.

In some embodiments, the present invention contemplates linking services and/or applications with transport for better performance and differential billing for advanced communication services.

At least some embodiments of the present invention contemplate utilizing an IP terminal device that manages (through an IP stack and a user agent) communications for the user.

The present invention will be readily adaptable to future wireless communication technology such as WiMAX (802.16) in combination with WLAN which will provide a less costly or supplementary technology to 3G.

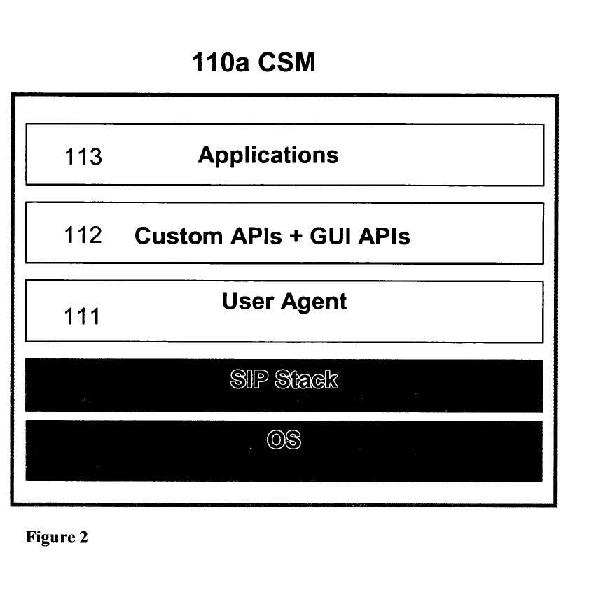

Referring to FIG. 2, client service manager 110a is shown having five layers: user applications 113, Custom APIs and GUI API 112, user agent 111, an SIP stack, and an OS. The lower two layers (the OS and the SIP stack) may include standard solutions (e.g., off-the-shelf component such as DiffServ supported Linux OS). UA 111 is responsible for linking the service class with a DSCP DiffServ Code Points, a 6 bit code used to mark the IP packet to differentiate IP traffic so the OS can mark each packet with a corresponding DSCP. The Custom APIs and GUI API 112 will be available for writing customized applications and services. Using Custom and the GUI API [112], communications applications [113] may be added or written to CSM 110a for requesting services from the Network Service Manager 120. The transport will use Wireless LAN technology for wireless communication. Custom and GUI APIs [112] may be supported by User Agent 111 which can be downloaded and deployed on the handheld device. In addition, other applications may be written using Custom and GUI APIs [112] including applications enabling services such as voice, multimedia, and messaging communications. In some cases, the Custom APIs maybe implemented as a separate element from GUI APIs.

The client hardware design may utilize industry standard practices using system-on-chip (SoC) technology. For example, embodiments of the present invention contemplate using a multi-core SoC having a generic purpose process core+DSP core+LCD controller+memory controller+various I/O interfaces. The DSP core may provide the processing power for applications. For example, the DSP core may process the TOS bits for class of service functions. In addition device 110 may include an RF module for WLAN. Similarly, device 110 may include a digital camera and interface, multimedia accelerator, etc.

UA 111 may include software installed on device 110 and act as a software agent on behalf of the user. UA 111 may be downloadable and upgradeable allowing device 110 to be reconfigured. In this manner, devices 110 may be targeted at different customer bases by just a software upgrade. In at least one embodiment, the client service manager 110a includes, for example, the following stacks:

IP stack (both IPv4 and IPv6 support) with both TCP/UDP and Diffserv enabled.

An operating system (for example, Linux).

Support for SIP, RTP, RTCP, and optional Voice CODEC.

Signaling for the client server manager 110a can be SIP. Voice functions may be provided by VOIP technology. In some embodiments, a speech engine may be embedded in the device as an input to compensate for the form factor in the handheld device.

In at least some embodiments, clients 110 utilize an IP stack with other protocol enabled (RTP, RTCP, RSVP, and SIP) on a handheld device. The client hardware, for example, can comprise custom designed handheld devices (using standard hardware components), out-of-the-box notebook PCs, or PDAs with a WLAN access card.

In addition, UA 111 may have a voice engine so applications can build a voice interface to take voice command (speech recognition). This will ease some difficulties in using key input on the small hand held devices. In some embodiments, voiceXML may be used to convert voice input into XML format for other information services such as asking for directions or movie listings. With the voice input option, the proposed handheld device can also help the segment of population who are not familiar (non-computer users) with PDA or handheld devices to easily start to use client 110. Different version or different user interfaces can be implemented via different software packages enabling device 110 to be tailored to different user groups (such as road warriors, teenage gamers, and elderly, etc.). For example, device 110 can include a special ‘panic button’ for the elderly or people with health problems to call emergency response organizations and/or relatives with the user's medical profile.

As discussed above, custom APIs and GUI APIs 112 are implemented to provide flexibility and consistency for the applications and services allowing UA 111 to be upgraded or revised. This is the new design feature that allows us to change the ‘skin’ of the devices to fit different markets needs (such as devices for the elderly, for teenagers, or for other vertical market). As a result, UA 111 may be revised to provide new functionality without having to change a hardware device or change the applications. Therefore, the changes of the device function are shielded from applications so the end user interfaces and their applications look the same and consistent. Applications and services can be developed with standard APIs provided by the platform so applications can be portable and allow developers to concentrate on building great applications.

In some implementations, GUI APIs 112 provides programming interfaces to the UA 111 as a separate layer (packages) as shown in FIG. 2. In another implementation, the Custom and GUI interface API can be incorporated into the UA 111.

As shown in FIG. 3, the NSM 120 includes a number of logical components: a proxy server 121 which receives and processes client requests, an authentication server 122 (in some embodiments, a AAA server (authentication, authorization and accounting could be used), a Registration Server 123 for user registration, a location server 124 for user presence and location information (for example, store users' current availability and location in the form of an IP address), an online billing and accounting server (OBAS) 125 for differential billing, the OBAS also keep track of subscriber's payments information, a Subscriber Database 126 to store subscriber information (such as ID, security credentials, service profile, personal preferences, etc.), an optional PKI server 127 which could provide user IDs as digital certificates, a provisioning server 128 that will process new user provisioning and payment information, it will also be used for user service (such as travel directions, intelligent call routing, info services, etc.) subscription, and application servers 129 which can provide other intelligent services, in some embodiment, there can be many applications server deployed in the network to provide different services. As will be described below the proxy server 121 manages service requests from clients 110 and forwards them to appropriate functions (see detailed flow chart 1 through 4). In some embodiment, there could be many proxy servers depending on the number of users in a certain market. For example, with registration requests, proxy server 121 forwards the requests to registrar 123. The interface between the clients and proxy server 121 may be SIP. The interfaces to/from the subscriber database 126 and between AAA server 122 and the OBS 125 may be Diameter-based (Diameter protocol for customer authentication, authorization, and accounting services). The interaction between the various servers will be further illustrated by flow charts (see FIGS. 5 to 9).

FIG. 4 illustrates an example of how the invention can be implemented to provide efficient and intelligent mobile services. According to aspects of the present invention, the components described in FIGS. 2-3 may used to “enable” management services. The actual data traffic flow can be described in FIG. 4 including linking application level service class with IP data transport.

As shown in FIG. 4, once data traffic is classified into service classes and marked with DSCP, it may be routed by the front-end service router 130 (in some embodiments, router 130 is the first element user traffic contacts within the contemplated network). FIG. 5 give an example of how messages flow through a service platform that uses all the three elements 110a, 120, and 130.

In addition, the service router 130 can be linked directly to the online billing server (OBS) 125 to do packet-based service class/type intelligent billing to support a variety of business models.

FIG. 5 illustrates is an example how the service platform address general message flow. Initially, a new user signs up and pays for services provided by the service platform. Once a user is provisioned into the system, the user can begin using services he/she subscribed for by starting the login application 113 on the client device 110. This process starts with a user logged into our network service manager 110a, once verified, an authorization token is sent to the user with his/her service profile (i.e. the services available to the user according to subscription and how the user prefer to use these services) by the network service manager 120. At this point, the user is ready to use any services he/she has subscribed to. When a user use an application 113, for example, to send a high priority message, the UA 111 checks the authorization, if allowed, the message is constructed and the high priority DSCP is marked on these packets containing the message. When the marked packets containing the message arrive at the front-end service router 130, it routes the message to, for example, a high priority message server based on the DSCP value of the IP packet. This allows a fast, efficient and intelligent delivery of different priority messages at the transport level. At the same time, if the accounting is enabled on the service router, a bill may be generated by the OBAS 125.

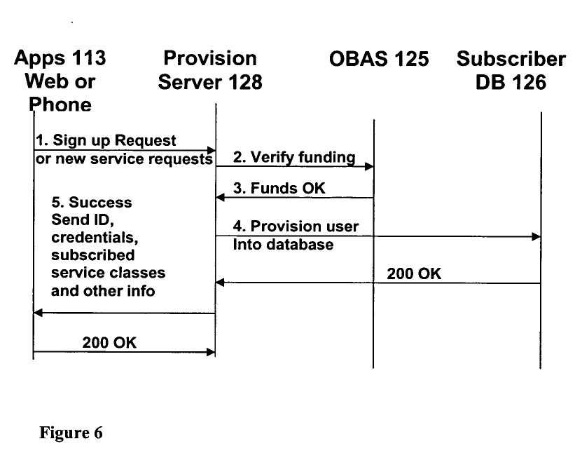

As depicted in FIG. 6, a new user will apply for an account by web, email, phone, etc. After verifying the identity of the user (and upon receiving funds from the user), provisioning server 129 generates a user account is created with a user ID (e.g., in the form of SIP URL such as: user_name@ourdomain.com), with a password (or a PKI key pair, provided by the PKI server 127). The account may also be associated with a user profile describing each of the available subscribed services (such as voice call service) (as determined by the user's level of service). The account may also include user preferences (such as who is allowed to call at what time, etc.). Account information may be stored in subscriber database 126. The subscribed services may include one of a number of predefined service classes that correspond to one of the DSCP. In addition, a web interface may be implemented to allow a user to self register and change their subscription details.

The same flow chart (FIG. 6) also illustrates how users can subscribe to new services. There are any numbers of ways for a subscriber to subscribe/unsubscribe for services. One is through the new user service creation process (e.g., via web, email, phone, etc.). The other way is through the user interface in device 110 which allows a user to browse for new services. In addition, a user can be prompted about new services using a ‘network push’ (such as SIP event notification framework, RFC 3265). All these actions will result in a request being sent to the AAA server 122 for authentication and then changes being made in the subscriber database. This process can be dynamic and services can be subscribed for ‘as needed’. For example, in a situation where a user is only subscribed to use voice phone calls, services may be added “on-the-fly”. Thus, during a call, when the user finds that he needs to see the other party, he can make a request and authorize additional payments to add a streaming video session to this call.

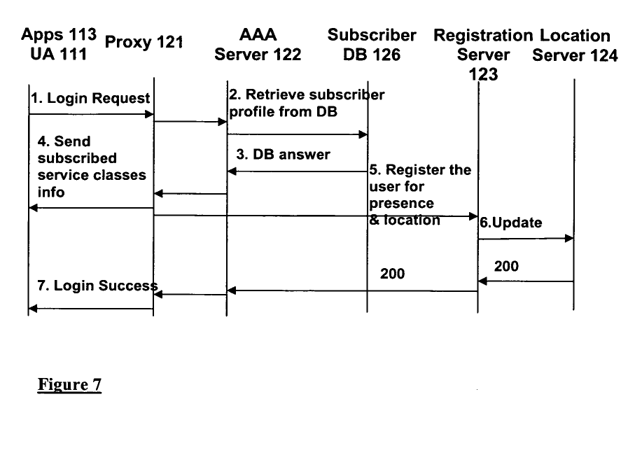

FIG. 7 illustrates a user login and registration process. After signing up for services, a customer will start or turn on device 110. At this time, device 110 automatically runs start up application 113. Application 113 logs into the system by sending a login request through User Agent 111 to proxy server 121. In turn, proxy server 121 sends an authentication request to authentication server 122. In the login request, the UA 111 includes the user ID and the sending device's IP address. If IPv6 is implemented, the IP address need not to be sent because the device will have a permanent IP address which is stored in the subscriber database 126 along with user ID and other information. The authentication server 122 verifies the user ID by checking data in the subscriber database 126 (use Diameter based Protocol). Once the verification is done, an authorization message is sent to the user agent 111 with permissions based on a user's subscribed service category. The Proxy Server then sends the subscriber information to the SIP registrar 123, which provides presence information for that particular user (also with user preferences such as which message is allowed and when/who can call the subscriber, etc.). After receiving the authorization information, UA 111 save that information on the local device and ensures that when the user uses a service (such as a phone call), the proper QoS code is encoded into the TOS field of the IP header for the associated packages. More specifically, UA 111 sets the precedence bit of an IP header.

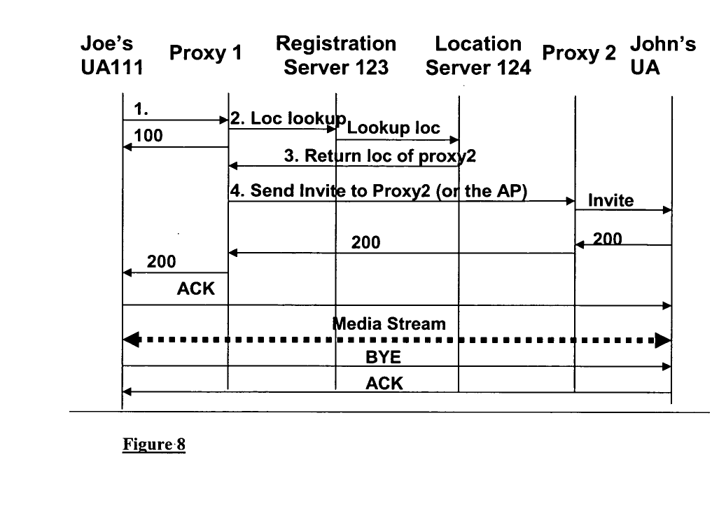

FIG. 8 depicts a process for making an outbound phone call. This will be handled by the SIP UA 111 installed on device 110. Embodiments of the present invention contemplate adding or assigning a priority code to the call. Specifically, UA 111 may assign a priority code to the call depending on the service classes the user subscribed to. This is directly coded into the TOS bits of the IP header so it can be given proper priority in the transport and also be logged for billing proposes (OBS 125).

Joe (using UA111) starts to make a call to his friend John (using UA111) by trying John's SIP URL (John@somewhere.com). Since the Joe's UA111 does not know where John is currently located, the proxy server 121 sends a query to the registration server 123 for the current location of John (provided that Joe has permission by John to “subscribe” or find John's presence or where about information). If John is currently registered with the system (logged on), there will be an entry in the location server 124 with the IP address of the AP John is currently attached to. Joe's proxy server will use that information to send the invite to this proxy (proxy2) who then forwards the request to John's UA 111. When John answers the call, the 200 OK message will contain the current IP address of the device John is using in the ‘contact’ field of the header message. This will enable Joe to call John later directly if neither has moved to a different location requiring use of a different AP. If a UA has moved, then a re-registration process will take place to update the current AP information in the location database.

Call Routing in WLAN Network (an Example):

The WLAN device uses access point (AP) as “base stations” that connect the wireless devices to the backbone network. Normally, due to the lack of public IPv4 addresses, the APs will assign a private IP address to each of the devices. In addition, since users move around different APs and log in and out often, these assigned private IP addresses are dynamically assigned using DHCP. How will another user know where a particular user is and how will the UA and network know where to route a call to a certain user at a given time? Our system will utilize the SIP registration mechanism with a new parameter in the SIP user registration messages to the registration server 123, which then sends that information to a location server 124. Here is how it works: when a user attached to an AP and logged in to our network, the UA 111 will send the registration information to a registration server 123 to register the user in our system. In that registration message, there will be normal information such as URLs, scripts, and users' preferences. It will also contain the AP's public IP address. This AP's address information is then saved in the location server (database) 124 along with all the other registration information. If a user wants to call this registered user, the UA will look up or subscribe the location information and the current AP's address. Then all packets pertaining to the call will be able to route to the destination. To facilitate the routing, all AP's IP addresses can be stored in a DNS server for fast lookup.

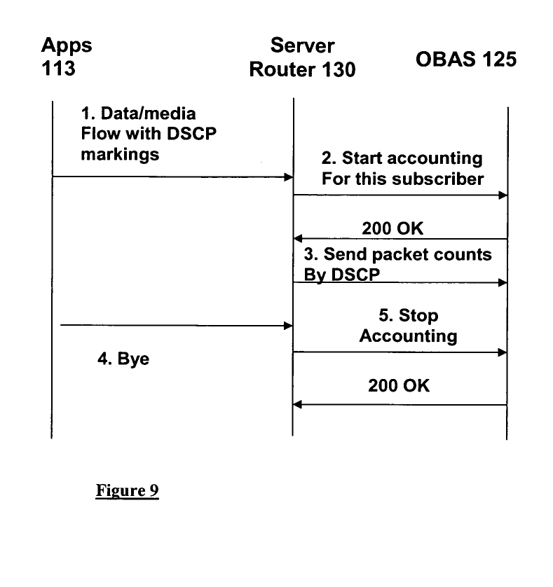

FIG. 9 depicts an example of differential billing using Front-end Server Router 130.

The present invention contemplates a flexible billing scheme depending on the business model. For example, billing can be facilitated by enabling the front-end router to send accounting packets directly to the OBS 125 for real time billing per client and per services (based on the service class or DSCP). For example, if a user wants to send a high priority message, the system first checks if the user has paid for the service, then when the user's message is sent, the packets are marked by proper DSCP code and the front-end service router will route the packet to the proper server and then it can send to the OBAS 125 the accounting info based on the DSCP in these packets. Once the packets are sent, the proper bill can be presented to the user.

The design of the system is intended for tight integration of the transport layer and the application layer. In other words the platform provides applications that are tightly connected with the underlying IP transport. One method of achieving this is to use service classification.

What is service classification? Not all services have the same requirements on the system. For example, a voice call requires a guaranteed bandwidth with little delay while a short message does not need to be delivered immediately. In order to manage resources efficiently, services may be divided into three main classes: real-time (such as voice call), synchronous (such as streaming video, audio, and e-commerce sessions), and asynchronous (such as emails and short messages). Other classes are also available (such as high versus low priority voice calls). These service classes will correspond directly with the IP precedence (first three bits of the TOS field in the IPv4 header) so that each class will have its own traffic priority and guaranteed bandwidth. DSCP (Diffserv Codepoint, 6 bits) can also be used to represent different classes with finer QoS control. For example, in the voice communication, a customer will pay for premium service that will allow higher levels of guaranteed service quality. Each IP packet of this user's current call session will have a precedence bit set at the highest number (e.g., 5) allowing priority routing to the destination. Different quality of services (QoS) can be achieved using advanced QoS techniques such as weighted fair queuing (WFQ), committed access rate (CAR), and random early detect (RED) services.

The advantages of the service class differentiation at the end points are the following:
1. It allows end-to-end QoS service which is very important in VOIP applications.
2. It enables a simple billing mechanism to bill based on these classes. This will have huge cost efficiency.
3. It allows us to bundle applications that have similar network requirements.
4. The service classes can be coded in terms of IP precedence levels or DSCP (Diffserv codepoint). This will link services directly with IP transport.
5. It can be managed and enforced by policies and SLAs.

The corresponding precedence bits or DSCP bits are normally set at the edge routers of a network. The drawback of this approach is that the DiffServ must guarantee all traffic crossing a particular interface in the network, rather than the circuit or the route of a particular call path. Therefore, a particular high priority call (or session) may degrade all other ongoing calls. To remedy this situation and to allow our system to be able to differentiate priority of calls based on service class of a particular caller (so it will have better service while not degrading and affecting other call sessions in progress), priority is set by user agents (e.g., UA 111) at the terminal devices (e.g., devices 110). This will give us more control over per call or per circuit quality. It also allows us to provide customized fine-grain control over applications and services on individual subscriber basis. It will also allow easy application management (such as application authentication and authorization).

Another advantage of setting the precedence bits or the DSCP bits at the end devices is that it will standardize the marking of these bits in our system, thus providing our network the means to intelligently route (130) user data traffic and also provides us a better way to bill our customs. After all, a service is only a service, not a business without proper billing mechanism.

Classifying services and setting the precedence bits at the source instead of edge routers will enable us to personalize services not only to that particular user but also to the services that a user is using. We can, for example, set the precedence bit for high priority for certain emergency voice calls or for someone that has paid a premium for some peak time calls. Alternatively, if someone only wants low cost services then all the services (even voice calls) will be placed at lower priority relative to other users.

In addition to the advantages of traffic (service session) management, the service classes will make charging and billing of services simple and yet detailed so each service can be billed at a different rate. This will help us to meet the different demands of different market segments and different users (a road warrior having to close a deal in a rush would care less about the cost of a call than a teenager wanting to chat with friends), thus increasing operating revenue. This is a sharp contrast to current billing method of counting total packets per month.

To lower computational burdens on devices 110, we can choose not to tag lower service class (such as asynchronous messages) to save processing power. Thus, in this embodiment, only certain levels of calls are tagged.

Our system can also be realized as a hardware element in the network that is placed at the edge (where the WLAN AS is located). The element is a proxy for the wireless end user devices which may lack memory and processing power. It will use service classification and mark packets as they come through. To the network (the edge router), this device acts as an end point except that it aggregates or proxies for many actual end device. This new proxy element has the advantage of adding our service platform functionality without modifying existing end user devices or the current deployed network infrastructure.

1. A method of provisioning communications services over an Internet Protocol-based network, comprising:
receiving an IP-based communication from a remote device associated with a user, wherein said communication comprises a header having a precedence level set by said remote device according to a level of service subscribed-to by said user;
provisioning a service to said remote device according to said precedence level.

2. The method of claim 1 further comprising billing said user according to said precedence level.

3. The method of claim 1 further comprising registering an IP address of said remote device and associating said device with said user prior to receiving said communication.

4. The method of claim 1, further comprising:
receiving a second IP-based communication from said remote device, said second communication requesting a change in level of service to a new service;
updating service details in a database associated with said user according to reflect said new service; and
transmitting instructions to said remote device for setting a communication precedence level associated with said new service.

5. The method of claim 4, comprising:
receiving a third IP-based communication from said remote device, requesting provisioning of said new service;
provisioning said new service, wherein said new service differs from said service.

6. The method of claim 1, wherein said service comprises at least one of a voice over IP call, an instant message, a chat session, and a web browse session.

7. The method of claim 1, wherein said precedence level comprises at least a first voice call level of priority and a second voice call level of priority, and wherein a bandwidth level associated with said first level of priority is greater than a bandwidth level associated with said second level of priority.

8. The method of claim 1, wherein said precedence level is set by configuring IP precedence bits of a message header.

9. The method of claim 1, wherein said precedence level is set by configuring Diffserv Codepoint bits of a message header.

10. The method of claim 1, wherein said precedence level is set by configuring IP precedence bits and by configuring Diffserv Codepoint bits of a message header.

11. A system for provisioning communications services over an Internet Protocol-based network, comprising:
means for receiving an IP-based communication from a remote device associated with a user, wherein said communication comprises a header having a precedence level set by said remote device according to a level of service subscribed-to by said user;
means for provisioning a service to said remote device according to said precedence level.

12. A router for use in provisioning communications services over an Internet Protocol-based network, comprising:
a receiving module for receiving an IP-based communication from a remote device associated with a user, wherein said communication comprises a header having a precedence level set by said remote device according to a level of service subscribed-to by said user;
a processor for analyzing said communication to determine said level of service subscribed to by said user; and
a transmitter for forwarding a service request to an appropriate provisioning service as determined by said processor.
